(19) United States
(12) Patent Application Publication
(10) Pub. No.: US 2023/0283930 A1
(43) Pub. Date: Sep. 7, 2023

(54) DAMPING DEVICE AND CPE ASSEMBLY

(71) Applicant: ZTE CORPORATION, Shenzhen (CN)

(72) Inventor: Lei ZHANG, Shenzhen (CN)

(21) Appl. No.: 18/006,655

(22) PCT Filed: Jun. 21, 2021
(86) PCT No.: PCT/CN2021/101252

§ 371 Date: Jan. 24, 2023

(30) Foreign Application Priority Data
Sep. 21, 2020 (CN) 202010994334.0

(51) Int. Cl. H04Q 1/02; H01Q 1/12

(52) U.S. Cl. CPC H04Q 1/025; H04Q 1/09; H01Q 1/1207

(57) ABSTRACT

A damping device and a CPE assembly are disclosed. The damping device may include a housing, a guide roller, a friction drum, and a buffer shaft. The buffer shaft includes a shaft body, and a buffer arranged in the housing. The shaft body has one end connected with the buffer and the other end arranged on the bottom plate of the housing. The guide roller is rotatably arranged on the shaft body. The friction drum is sleeved on the guide roller, the guide roller has an outer diameter less than an inner size of the friction drum. The housing is provided with a first wire inlet hole and a first wire outlet hole in a sidewall, and the friction drum is provided with a second wire inlet hole and a second wire outlet hole respectively opposite to the first wire inlet hole and the first wire outlet hole.

### CROSS-REFERENCE TO RELATED APPLICATION

This application is a national stage filing under 35 U.S.C. § 371 of international application number PCT/CN2021/101252, filed Jun. 21, 2021, which claims priority to Chinese patent application No. 202010994334.0 filed on Sep. 21, 2020. The contents of these applications are incorporated herein by reference in their entirety.

### TECHNICAL FIELD

The present disclosure relates to the field of electronic equipment, and in particular to a damping device and a Customer Premise Equipment (CPE) assembly including the damping device.

### BACKGROUND

Outdoor equipment, such as the 5G Customer Premise Equipment (CPE), needs to be fixed on an outdoor installation foundation (e.g., a wall or a utility pole). At present, fixing devices for fixing outdoor equipment mainly include holding poles, expansion screws, sticking back adhesive, and the like. Once the fixing device fails, the outdoor equipment will fall from the installation foundation, leading to a risk of injuring people.

### SUMMARY

The present disclosure relates to a damping device and a CPE assembly including the damping device.

In accordance with an aspect of the present disclosure, an embodiment provides a damping device. The device may include: a housing, a guide roller, a friction drum, and a buffer shaft. The buffer shaft includes a shaft body and a buffer. A mounting portion of the buffer is fixedly arranged in the housing relative to the friction drum, and one end of the shaft body is connected with the buffer. The other end of the shaft body is arranged on a bottom plate of the housing, and the guide roller is rotatably arranged on the shaft body. The friction drum is sleeved on the guide roller and separated from the housing, and the guide roller has an outer diameter less than an inner size of the friction drum, so that there exists a gap between an inner surface of the friction drum and an outer surface of the guide roller. The housing is provided with a first wire inlet hole and a first wire outlet hole in a sidewall. The friction drum is provided with a second wire inlet hole and a second wire outlet hole. When the first wire inlet hole is aligned with the second wire inlet hole, the first wire outlet hole can be aligned with the second wire outlet hole.

According to another aspect of the present disclosure, an embodiment provides a CPE assembly. The CPE assembly may include a CPE. The CPE assembly may further include a damping device, which is the damping device according to the present disclosure. A wire of the CPE is passed through the first wire inlet hole and the second wire inlet hole respectively to enter the gap between the friction drum and the guide roller. Then, the wire goes around the guide roller and is passed through the second wire outlet hole and the first wire outlet hole to get out of the damping device.

### BRIEF DESCRIPTION OF DRAWINGS

FIG. 1 is a schematic three-dimensional structural diagram of an implementation of a damping device according to the present disclosure;

FIG. 2 is a schematic diagram of an implementation of the damping device with a top plate of a housing removed;

FIG. 3 is a schematic diagram of a friction drum in the damping device in a non-offset state;

FIG. 4 is a schematic diagram of the friction drum in the damping device in an offset state;

FIG. 5 is a schematic diagram of the damping device viewed from the side of the top plate; and

FIG. 6 is a schematic diagram of the damping device viewed from the side of a bottom plate.

### DETAILED DESCRIPTION

In order to make those having ordinary skills in the art to better understand the technical schemes of the present disclosure, a damping device and a CPE assembly including the damping device according to the present disclosure will be described in detail below in conjunction with the accompanying drawings.

Embodiments of the present disclosure will be more fully described hereinafter with reference to the accompanying drawings, but the embodiments may be embodied in different forms, and should not be construed as being limited to the embodiments set forth herein. On the contrary, these embodiments are provided to make the present disclosure thorough and complete, and enable those having ordinary skills in the art to fully understand the scope of the present disclosure.

The various embodiments in the present disclosure and the various features in the embodiments can be combined to derive other embodiments not explicitly described.

As used herein, the term “and/or” includes any and all combinations of one or more related enumerated items.

The terms used herein are only used to describe specific embodiments, and are not intended to limit the present disclosure. As used herein, singular forms “a” and “the” are also intended to include plural forms, unless otherwise indicated clearly in the context. It should be also understood that when used in the present description, the terms “include” and “made of” specify the presence of said features, integers, steps, operations, elements and/or components, but do not exclude the presence or addition of one or more other features, integers, steps, operations, elements, components and/or groups thereof.

Unless otherwise defined, all the terms (including technical and scientific terms) used herein have the same meanings as commonly understood by those having ordinary skills in the art. It will also be understood that terms such as those defined in commonly used dictionaries should be interpreted as having meanings consistent with their meanings in the backgrounds of the related art and the present disclosure, and will not be interpreted as having idealized or over-formal meanings, unless so defined explicitly herein.

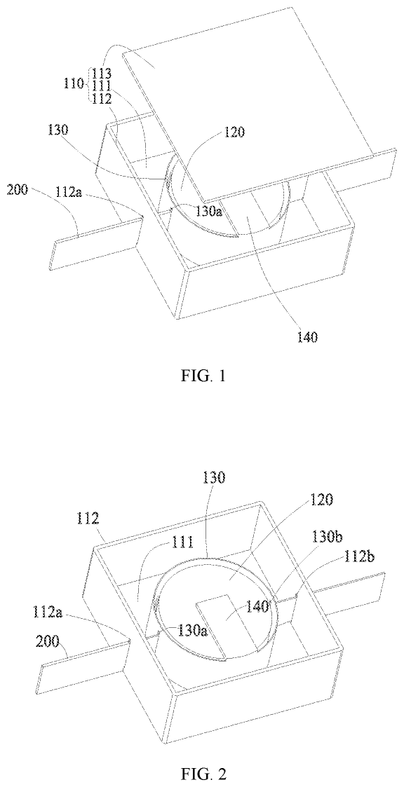

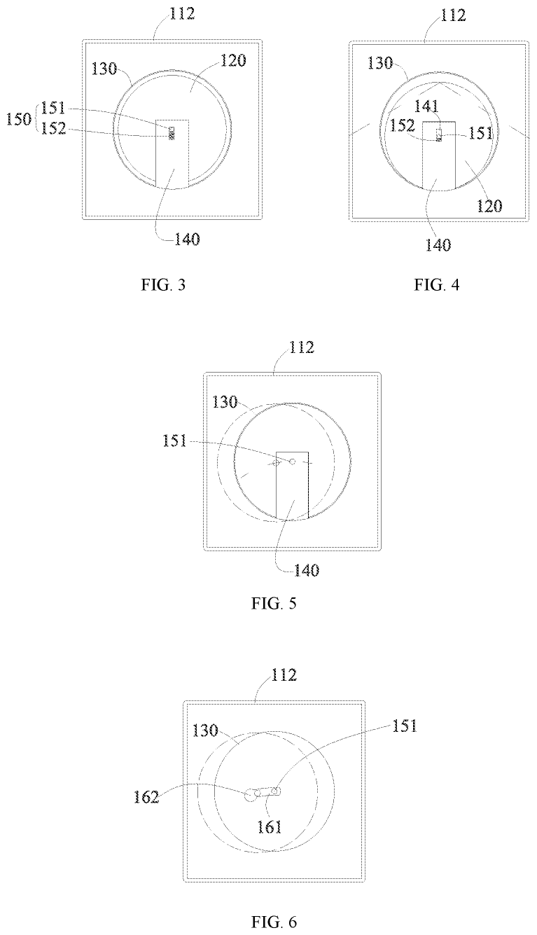

According to an aspect of the present disclosure, a damping device is provided. As shown in FIGS. 1 and 2, the damping device includes a housing 110, a guide roller 120, a friction drum 130, and a buffer shaft (see reference numeral 150 in FIG. 3). As shown in FIGS. 3 and 4, the buffer shaft 150 includes a shaft body 151 and a buffer 152.

A mounting portion of the buffer 152 is fixedly arranged in the housing 110 relative to the friction drum 130, and one end of the shaft body 151 is connected with the buffer 152.

The other end of the shaft body 151 is arranged on a bottom plate of the housing 110, and the guide roller 120 is rotatably arranged on the shaft body 151.

The friction drum 130 is sleeved on the guide roller 120 and separated from the housing 110. The guide roller 120 has an outer diameter less than an inner size of the friction drum 130, so that there exists a gap between an inner surface of the friction drum 130 and an outer surface of the guide roller 120.

The housing 110 is provided with a first wire inlet hole 112a and a first wire outlet hole 112b in a sidewall 112. The friction drum 130 is provided with a second wire inlet hole 130a and a second wire outlet hole 130b. When the first wire inlet hole 112a is aligned with the second wire inlet hole 130a, the first wire outlet hole 112b can be aligned with the second wire outlet hole 130b.

The damping device according to the present disclosure is used cooperatively with outdoor equipment (e.g., CPE), with the outdoor equipment arranged outdoors and the damping device according to the present disclosure arranged indoors. During mounting, one end of a wire 200 of the outdoor equipment is passed through the first wire inlet hole 112a of the housing 110 to enter the housing 110, and then passed through the second wire inlet hole 130a of the friction drum 130 to enter the gap between the friction drum 130 and the guide roller 120. The wire goes around the guide roller 120 in the gap between the friction drum 130 and the guide roller 120 and is passed through the second wire outlet hole 130b in the friction drum 130. Finally, the wire is passed through the first wire outlet hole 112b in the sidewall 112 of the housing 110 to get out of the damping device, and is connected to indoor electronic equipment, so that the friction drum 130 is suspended in the housing 110 by the wire 200 under an initial state.

When the outdoor equipment is fixed on a corresponding installation foundation, as shown in FIG. 3, in the damping device, the friction drum 130 is suspended in the housing 110 of the damping device under the action of the wire 200, and the guide roller 120 is not in contact with the friction drum 130. When the wire 200 is pulled at a low speed, the guide roller 120 can rotate around the shaft body, to complete the assembly of the damping device with the wire of outdoor equipment.

In the damping device, the guide roller 120 is arranged in the housing by means of the buffer shaft. When the buffer 152 is subjected to an external force, the buffer 152 is elastically deformed, and thus can move within a certain range. Therefore, when the wire 200 is subjected to an external force, the force is transferred to the friction drum 130, and the mounting portion of the buffer 152 can move within a certain range under the drive of the friction drum 130. Since there exists the gap between the guide roller 120 and the friction drum 130, when the friction drum 130 moves to a position where the inner surface of the friction drum 130 is in contact with the outer surface of the guide roller 120, if the wire continues to move and drive the guide roller 120 to rotate, a friction force will be generated between the guide roller 120 and the friction drum 130 to prevent further rotation of the guide roller 120.

If the fixing device of the outdoor equipment fails and the outdoor equipment comes off from the installation foundation and drops down, the wire will be driven to move down. As shown in FIG. 4, under the downward force brought by the outdoor equipment, the wire tends to change from a curved state into a straight state, to lift the friction drum 130, and the friction drum 130 drives the buffer 152 to move up, resulting that the guide roller 120 generates an acting force on the buffer 152 to compress the buffer 152. Consequently, the buffer 152 is elastically deformed to an extent that the friction drum 130 comes into contact with the guide roller 120. After the guide roller 120 comes into contact with the friction drum 130, the guide roller 120 is stuck under the action of the friction force and cannot further rotate around the shaft body 151. During the dropping of the outdoor equipment, the wire is always closely bonded to the guide roller 120, so there also exists a friction force between the surface of the wire and the surface of the guide roller 120. When the guide roller 120 is stuck to stop rotating, the wire cannot quickly slide over the guide roller 120 as well, resulting in that the moving speed of the wire is decreased or even the wire stops moving. After the moving speed of the wire is decreased, the dropping speed of the outdoor equipment connected with the wire is decreased as well. After the wire stops moving, the outdoor equipment stops dropping as well. Thus, the risk of the outdoor equipment coming off from the installation foundation to injure people can be decreased.

It should also be noted that since the buffer 152 can be elastically deformed under the effect of an external force, when the outdoor equipment drops, due to a buffering effect of the buffer 152, the wire moves for a short period of time rather than stops immediately. Therefore, the damping device according to the present disclosure can also prevent the wire from being broken due to a sudden stop, thereby preventing the outdoor equipment from stopping operation due to dropping and preventing the dropping of the outdoor equipment from affecting the use of the outdoor equipment by users. For example, when the outdoor equipment is CPE, the provision of the damping device on the wire of the CPE can prevent communication interruption.

When the buffer 152 is in a deformed state, there exists elastic potential energy, which generates a restoring force after being released. After the force applied on the wire by the outdoor equipment due to dropping is released (for example, after the outdoor equipment is fixedly remounted), the elastic potential energy is released. Under the effect of the restoring force of the buffer 152, the friction drum 130 can return to an initial position (i.e., a position where the friction drum 130 is located when the buffer 152 is in an initial state). When the wire is gently pulled, the guide roller 120 will rotate and allow the wire to pass through the damping device, and the remounting of the outdoor equipment and corresponding components can be completed.

In the present disclosure, the specific structure of the buffer 152 is not particularly limited. For example, the buffer 152 may be a spring, an elastic sheet or other elastic structures. The buffer 152 may also be an electromagnet. When the guide roller 120 drops into contact with the friction drum, the electromagnet can be energized and attracts a magnetically conductive part arranged on the guide roller 120 or the friction drum 130, such that the guide roller 120 comes into contact with the friction drum 130 and generates a friction force.

In the present disclosure, there is no particular requirement for the surface state of the friction drum 130, as long as the friction force generated when the inner surface of the friction drum 130 is in contact with the outer surface of the guide roller 120 can prevent the guide roller 120 from continuing to rotate.

In the present disclosure, there is no particular limitation on the materials of the friction drum 130 and the guide roller 120. For example, the friction drum 130 and the guide roller 120 may be made of plastic, respectively.

In the present disclosure, the specific structure of the housing 110 is not particularly limited as well. For example, as shown in FIGS. 1 and 2, the housing 110 may include a bottom plate 111, a sidewall 112 arranged around the bottom plate 111, and a top plate 113 arranged opposite to the bottom plate 111. It should be noted that although the housing 110 shown in FIGS. 1 and 2 is of a rectangular octahedral structure, the present disclosure is not limited thereto, and the housing 110 may also be of other structures such as a cylindrical structure or a prismatic structure.

In the present disclosure, there is no particular limitation on how to fix the friction drum 130 relative to the mounting portion of the buffer 152. For example, the buffer 152 may be directly arranged on the wall of the friction drum by utilizing an adhesive, or a fastener.

In the present disclosure, in order to facilitate arrangement, the damping device may further include a mounting plate 140. The mounting plate 140 is fixedly arranged at one end of the friction drum 130 facing away from the bottom plate 111 and is arranged opposite to the bottom plate 111. The mounting plate 140 extends toward the interior of the friction drum 130 such that at least a part of an orthographic projection of the mounting plate 140 on the bottom plate 111 falls within an area defined by an orthographic projection of the friction drum 130 on the bottom plate 111. The mounting portion of the buffer 152 is fixedly arranged on a part of the mounting plate 140 corresponding to an internal space of the friction drum 130.

By provision of the mounting plate 140, the shaft body 151 can be located inside the friction drum 130, and the guide roller 120 can be conveniently mounted, to allow a gap to exist between the outer surface of the guide roller 120 and the inner surface of the friction drum 130.

As an implementation, if there is no external force after the damping device is assembled, the outer surface of the guide roller 120 is evenly spaced from the inner surface of the friction drum 130. Accordingly, after the damping device is assembled and the wire 200 is passed through the damping device, since the friction drum 130 is a cylinder, the axis of the shaft body 151 coincides with the axis of the friction drum 130 in case of no external force. When the friction drum 130 is a cylinder, the outer diameter of the guide roller 120 is less than an inner diameter of the friction drum 130.

In order to limit the moving range of the friction drum 130, as an implementation, as shown in FIG. 4, the mounting plate 140 is provided with a mounting hole 141. The buffer 152 is arranged in the mounting hole 141, and one end of the shaft body 151 is inserted into the mounting hole 141.

Because the mounting hole 141 has a limited size, the one end of the shaft body 151 can only move in a space defined by the mounting hole 141, thus ensuring that the friction drum 130 can inevitably move to a position where the friction drum 130 is in contact with the guide roller 120. Moreover, once the friction drum 130 moves to the position where it is in contact with the guide roller 120, the friction drum 130 will not make a large movement, ensuring that the friction force between the guide roller 120 and the friction drum 130 can lock the guide roller.

In the present disclosure, the mounting hole 141 may or may not run through the mounting plate 140 in a thickness direction, as long as one opening of the mounting hole faces the bottom plate of the housing.

As an implementation, the mounting hole is rectangular, and when the damping device and the outdoor equipment are mounted in place, a length direction of the mounting hole is a vertical direction. Thus, the end of the shaft body 151 facing away from the bottom plate of the housing can reciprocate in the vertical direction under the restriction of the mounting hole 141.

As described above, the housing 110 includes the bottom plate 111, and one end of the shaft body 151 faces the bottom plate 111. In the present disclosure, there is no particular limitation on how the shaft body 151 is mounted on the bottom plate 111 of the housing 110. For example, the shaft body 151 may be adhered to the bottom plate 111 by an adhesive, or the bottom plate 111 may be provided with a mounting hole into which the shaft body 151 is inserted.

In the embodiment shown in FIG. 6, the bottom plate 111 is provided with an arc-shaped guide slot 161, and the other end of the shaft body 151 is inserted into the arc-shaped guide slot 161. Thus, after the buffer 152 is compressed and brings the guide roller 120 into contact with the friction drum 130, under the further action of the wire, one end of the shaft body 151 can still swing under the guidance of the guide slot 161, increasing the duration of an impact from the wire on the damping device, and thus the impact of the damping device can be reduced (correspondingly, a counter-acting force applied on the wire by the damping device can be reduced). That is, the guide roller 120 will not stop rotating suddenly, preventing the wire from being broken due to a sudden stop of the guide roller 120. As an implementation, when the force received by the buffer 152 is greater than twice an initial elastic force of the buffer 152, the shaft body 151 swings under the guidance of the guide slot 161.

FIG. 5 is a schematic diagram of the damping device viewed from the side of the top plate. The circular dotted line in FIG. 5 shows an outline of an end face of the friction drum 130 facing the bottom plate of the housing, and the arc-shaped dotted line in FIG. 5 shows a moving trajectory of one end of the shaft body 151 located in the guide slot 161.

FIG. 6 is a schematic diagram of the damping device viewed from the side of the bottom plate. The circular dotted line in FIG. 6 shows an outline of an end face of the friction drum 130 facing away from the bottom plate of the housing. Moreover, FIG. 6 also shows that the shaft body 151 can slide under the guidance of the guide slot 161.

In order to facilitate the restoration of the friction drum 130, as an implementation, the housing is further provided with an auxiliary restoring mechanism on the bottom plate. The auxiliary restoring mechanism is arranged at one end of the guide slot and can provide the shaft body with a thrust for moving away from the auxiliary restoring mechanism when the shaft body is in contact with the auxiliary restoring mechanism.

In the present disclosure, the specific structure of the auxiliary restoring mechanism is not particularly limited. For example, the auxiliary restoring mechanism may be a spring or an elastic sheet arranged at a tail end of the guide slot. When the shaft body moves to the tail end of the guide slot, the shaft body compresses the auxiliary restoring mechanism, and a restoring force generated by the auxiliary restoring mechanism helps the shaft body drive the friction drum to return to the initial position.

As an implementation, as shown in FIG. 6, the housing is further provided with an accommodating cavity 162 communicating with the arc-shaped guide slot 161 on the bottom plate. One end of the shaft body 151 facing the bottom plate of the housing is inserted into the guide slot 161 to come into sealed contact with a sidewall of the guide slot 161. The damping device may further include a retractable cover, which is arranged on the bottom plate of the housing and covers the accommodating cavity. The retractable cover is in sealed contact with the shaft body and can extend and retract with the movement of the shaft body, such that a sealed chamber is defined by the accommodating cavity, the guide slot, the retractable cover and the shaft body.

When the damping device in use, hydraulic oil may be arranged in the accommodating cavity. Since the guide slot communicates with the accommodating cavity, when the shaft body is at the initial position, the hydraulic oil is distributed in the guide slot and the accommodating cavity. After the shaft body swings to completely press the hydraulic oil into the accommodating cavity, the hydraulic oil will generate a pressure to push the shaft body, helping restoring the shaft body.

In the present disclosure, the hydraulic oil may not be injected into the accommodating cavity 162 of the damping device first. Only when the damping device needs to be assembled with the outdoor equipment, is the hydraulic oil injected into the accommodating cavity 162.

In order to facilitate operation, the hydraulic oil may be arranged in advance into the sealed chamber formed by the accommodating cavity 162, the guide slot 161 and the retractable cover.

Of course, gas pressure generated by compressed gas can also be used to help restore the shaft body instead of arranging the hydraulic oil in the accommodating cavity.

As described above, the wire 200 goes around the guide roller 120 in the gap between the guide roller 120 and the friction drum 130. In order to facilitate the wire 200 to drive the guide roller 120 to rotate and to realize self-locking after the guide roller 120 comes into contact with the friction drum 130, the wire 200 may go around the guide roller 120 by half a circle.

The friction drum 130 and the housing 110 are arranged such that when the wire 200 is passed through the first wire inlet hole, the second wire inlet hole, the second wire outlet hole and the first wire outlet hole in sequence and the buffer 152 is in the initial state, the first wire inlet hole, the second wire inlet hole, the second wire outlet hole and the first wire outlet hole are arranged on the same straight line, so that the wire goes around the guide roller by at least half a circle. That is, when the friction drum 130 is in the initial state, the first wire inlet hole 112a, the second wire inlet hole 130a, the second wire outlet hole 130b and the first wire outlet hole 112b are sequentially arranged on the same straight line, so that the wire goes around the guide roller by at least half a circle.

As an implementation of the present disclosure, as shown in FIG. 2, the friction drum 130 and the housing 110 are arranged such that when the wire 200 is passed through the first wire inlet hole, the second wire inlet hole, the second wire outlet hole and the first wire outlet hole in sequence and the buffer 152 is in the initial state, the first wire inlet hole 112a, the second wire inlet hole 130a, the second wire outlet hole 130b and the first wire outlet hole 112b are sequentially arranged on a straight line where the diameter of the guide roller 120 is located, so that the wire 200 can go around the guide roller 120 by half a circle. That is, when the friction drum 130 is in the initial state, the first wire inlet hole 112a, the second wire inlet hole 130a, the second wire outlet hole 130b and the first wire outlet hole 112b are sequentially arranged on the straight line where the diameter of the guide roller 120 is located, so that the wire 200 can go around the guide roller 120 by half a circle.

In another aspect of the present disclosure, a CPE assembly is provided, which includes a CPE. The CPE assembly further includes the damping device described above according to the embodiments of the present disclosure. A wire of the CPE is passed through the first wire inlet hole and the second wire inlet hole respectively to enter the gap between the friction drum and the guide roller, and the wire goes around the guide roller and is passed through the second wire outlet hole and the first wire outlet hole to get out of the damping device.

During use, the CPE is arranged outdoors, and the damping device according to the present disclosure is arranged indoors. During mounting, one end of the wire 200 of the CPE is passed through the first wire inlet hole 112a of the housing 110 to enter the housing 110, and the end of the wire 200 is then passed through the second wire inlet hole 130a of the friction drum 130 to enter the gap between the friction drum 130 and the guide roller 120. The wire goes around the guide roller 120 in the gap between the friction drum 130 and the guide roller 120 and is passed through the second wire outlet hole 130b in the friction drum 130. Finally, the wire is passed through the first wire outlet hole 112b in the sidewall 112 of the housing 110 to get out of the damping device, and is connected to indoor electronic equipment. Thus, the friction drum 130 is suspended in the housing 110 by the wire 200 in an initial state.

When the CPE is fixed on a corresponding installation foundation, as shown in FIG. 3, in the damping device, the friction drum 130 is suspended in the housing 110 of the damping device under the action of the wire 200, and the guide roller 120 is not in contact with the friction drum 130. When the wire 200 is pulled at a low speed, the guide roller 120 can rotate around the shaft body, to complete the assembly of the damping device with the wire of outdoor equipment.

In the damping device, the guide roller 120 is arranged in the housing by means of the buffer shaft. When the buffer 152 is subjected to an external force, the buffer 152 is elastically deformed, and thus can move within a certain range. Therefore, when the wire 200 is subjected to an external force, the force is transferred to the shaft body 151, and the buffer 152 can move within a certain range under the drive of the shaft body 151, so that the friction drum 130 can also move within a certain range. Since there exists the gap between the guide roller 120 and the friction drum 130, when the friction drum 130 moves to a position where the inner surface of the friction drum 130 is in contact with the outer surface of the guide roller 120, if the wire continues to move and drive the guide roller 120 to rotate, a friction force will be generated between the guide roller 120 and the friction drum 130 to prevent further rotation of the guide roller 120.

If the fixing device of the CPE fails and the CPE comes off from the installation foundation and drops down, the wire will be driven to move down. As shown in FIG. 4, the wire is subjected to a downward force brought by the outdoor equipment, and the guide roller 120 drives the shaft body 151 to press the buffer 152, so that the buffer 152 is elastically deformed to an extent that the friction drum 130 comes into contact with the guide roller 120. After the guide roller 120 comes into contact with the friction drum 130, the guide roller 120 is stuck under the effect of the friction force and cannot further rotate around the shaft body 151. During the dropping of the CPE, the wire is always tightly closely bonded to the guide roller 120, so there also exists a friction force between the surface of the wire and the surface of the guide roller 120. When the guide roller 120 is stuck to stop rotating, the wire cannot quickly slide over the guide roller 120 as well, resulting in that the moving speed of the wire is decreased or even the wire stops moving. After the moving speed of the wire is decreased, the dropping speed of the CPE connected with the wire is decreased as well. After the wire stops moving, the CPE stops dropping as well. Thus, the risk of the CPE coming off from the installation foundation to injure people can be decreased.

It should also be noted that since the buffer 152 can be elastically deformed under the effect of an external force, when the CPE drops, due to a buffering effect of the buffer 152, the wire moves for a short period of time rather than stops moving immediately. Therefore, the damping device according to the present disclosure can also prevent the wire from being broken due to a sudden stop, thereby preventing the CPE from stopping operation due to dropping and preventing communication interruption.

When the buffer 152 is in a deformed state, a restoring force can be generated. After the force applied on the wire by the CPE due to dropping is released (for example, after the CPE is fixedly remounted), the elastic potential energy is released. Under the effect of the restoring force of the buffer 152, the friction drum 130 can return to an initial position. When the wire is gently pulled, the guide roller 120 will rotate and allow the wire to pass through the damping device, and the remounting of the CPE and corresponding components can be completed.

For the CPE, the wire 200 is a data cable.

The exemplary embodiments have been disclosed herein, and although specific terms are used, these terms are only intended to be and should only be interpreted in a general illustrative sense, and are not used for the purpose of limitation. In some examples, it is apparent to those having ordinary skills in the art that the features, characteristics and/or elements described in conjunction with the specific embodiments may be used alone or in combination with those described in conjunction with other embodiments, unless otherwise stated explicitly. Therefore, it will be understood by those having ordinary skills in the art that various modifications in form and details can be made without departing from the scope of the present disclosure set forth by the appended claims.

1. A damping device, comprising: a housing, a guide roller, a friction drum, and a buffer shaft, the buffer shaft comprising a shaft body and a buffer, wherein:
a mounting portion of the buffer is fixedly arranged in the housing relative to the friction drum, and one end of the shaft body is connected with the buffer;
the other end of the shaft body is arranged on a bottom plate of the housing, and the guide roller is rotatably arranged on the shaft body;
the friction drum is sleeved on the guide roller and separated from the housing, and the guide roller has an outer diameter less than an inner size of the friction drum, so that there exists a gap between an inner surface of the friction drum and an outer surface of the guide roller; and
the housing is provided with a first wire inlet hole and a first wire outlet hole in a sidewall, the friction drum is provided with a second wire inlet hole and a second wire outlet hole, and the first wire outlet hole is arranged to be aligned with the second wire outlet hole when the first wire inlet hole is aligned with the second wire inlet hole.

2. The damping device of claim 1, further comprising:
a mounting plate, wherein the mounting plate is fixedly arranged at one end of the friction drum facing away from the bottom plate and is arranged opposite to the bottom plate,
at least a part of an orthographic projection of the mounting plate on the bottom plate falls within an area defined by an orthographic projection of the friction drum on the bottom plate, and
the mounting portion of the buffer is fixedly arranged on a part of the mounting plate corresponding to an internal space of the friction drum.

3. The damping device of claim 2, wherein
the mounting plate is provided with a mounting hole,
the buffer is arranged in the mounting hole, and
one end of the shaft body facing away from the bottom plate of the housing is inserted into the mounting hole.

4. The damping device of claim 1, wherein
the bottom plate of the housing is provided with a guide slot,
one end of the shaft body facing the bottom plate of the housing is inserted into the guide slot, and
the guide slot is arc-shaped.

5. The damping device of claim 4, wherein the housing is further provided with an auxiliary restoring mechanism on the bottom plate, and
the auxiliary restoring mechanism is arranged at one end of the guide slot and is configured to provide the shaft body with a thrust for moving away from the auxiliary restoring mechanism in response to the shaft body being in contact with the auxiliary restoring mechanism.

6. The damping device of claim 5, wherein the auxiliary restoring mechanism comprises a retractable cover and an accommodating cavity communicating with the guide slot,
one end of the shaft body facing the bottom plate of the housing is inserted into the guide slot to be in a sealed contact with a sidewall of the guide slot,
the retractable cover is arranged on the bottom plate of the housing and covers the accommodating cavity,
the retractable cover is in sealed contact with the shaft body and is capable of extending and retracting with movement of the shaft body, such that a sealed chamber is defined by the accommodating cavity, the guide slot, the retractable cover and the shaft body.

7. The damping device of claim 6, wherein hydraulic oil is provided in the sealed chamber defined by the accommodating cavity, the guide slot, the retractable cover and the shaft body.

8. The damping device of claim 1, wherein the friction drum and the housing are arranged such that when a wire is passed through the first wire inlet hole, the second wire inlet hole, the second wire outlet hole and the first wire outlet hole in sequence and the buffer is in an initial state,
the first wire inlet hole, the second wire inlet hole, the second wire outlet hole and the first wire outlet hole are arranged on a same straight line, so that the wire goes around the guide roller by at least half a circle.

9. The damping device of claim 8, wherein the friction drum and the housing are arranged such that when a wire is passed through the first wire inlet hole, the second wire inlet hole, the second wire outlet hole and the first wire outlet hole in sequence and the buffer is in the initial state,
the first wire inlet hole, the second wire inlet hole, the second wire outlet hole and the first wire outlet hole are arranged along a straight line where a diameter of the guide roller is located.

10. A Customer Premise Equipment (CPE) assembly, comprising a CPE, wherein the CPE assembly further comprises the damping device of claim 1,
a wire of the CPE is passed through the first wire inlet hole and the second wire inlet hole respectively to enter a gap between the friction drum and the guide roller, and
the wire goes around the guide roller and is passed through the second wire outlet hole and the first wire outlet hole to get out of the damping device.

11. The CPE assembly of claim 10, wherein damping device the further comprises:
a mounting plate, wherein the mounting plate is fixedly arranged at one end of the friction drum facing away from the bottom plate and is arranged opposite to the bottom plate,
at least a part of an orthographic projection of the mounting plate on the bottom plate falls within an area defined by an orthographic projection of the friction drum on the bottom plate, and
the mounting portion of the buffer is fixedly arranged on a part of the mounting plate corresponding to an internal space of the friction drum.

12. The CPE assembly of claim 11, wherein the mounting plate is provided with a mounting hole,
the buffer is arranged in the mounting hole, and
one end of the shaft body facing away from the bottom plate of the housing is inserted into the mounting hole.

13. The CPE assembly of claim 10, wherein the bottom plate of the housing is provided with a guide slot,
one end of the shaft body facing the bottom plate of the housing is inserted into the guide slot, and
the guide slot is arc-shaped.

14. The CPE assembly of claim 13, wherein the housing is further provided with an auxiliary restoring mechanism on the bottom plate, and
the auxiliary restoring mechanism is arranged at one end of the guide slot and is configured to provide the shaft body with a thrust for moving away from the auxiliary restoring mechanism in response to the shaft body being in contact with the auxiliary restoring mechanism.

15. The CPE assembly of claim 14, wherein the auxiliary restoring mechanism comprises a retractable cover and an accommodating cavity communicating with the guide slot,
one end of the shaft body facing the bottom plate of the housing is inserted into the guide slot to be in a sealed contact with a sidewall of the guide slot,
the retractable cover is arranged on the bottom plate of the housing and covers the accommodating cavity,
the retractable cover is in sealed contact with the shaft body and is capable of extending and retracting with movement of the shaft body,
such that a sealed chamber is defined by the accommodating cavity, the guide slot, the retractable cover and the shaft body.

16. The CPE assembly of claim 15, wherein hydraulic oil is provided in the sealed chamber defined by the accommodating cavity, the guide slot, the retractable cover and the shaft body.

17. The CPE assembly of claim 10, wherein the friction drum and the housing are arranged such that when a wire is passed through the first wire inlet hole, the second wire inlet hole, the second wire outlet hole and the first wire outlet hole in sequence and the buffer is in an initial state,
the first wire inlet hole, the second wire inlet hole, the second wire outlet hole and the first wire outlet hole are arranged on a same straight line, so that the wire goes around the guide roller by at least half a circle.

18. The CPE assembly of claim 17, wherein the friction drum and the housing are arranged such that when a wire is passed through the first wire inlet hole, the second wire inlet hole, the second wire outlet hole and the first wire outlet hole in sequence and the buffer is in the initial state,
the first wire inlet hole, the second wire inlet hole, the second wire outlet hole and the first wire outlet hole are arranged along a straight line where a diameter of the guide roller is located.

19. The damping device of claim 2, wherein the bottom plate of the housing is provided with a guide slot,
one end of the shaft body facing the bottom plate of the housing is inserted into the guide slot, and
the guide slot is arc-shaped.

20. The damping device of claim 3, wherein the bottom plate of the housing is provided with a guide slot,
one end of the shaft body facing the bottom plate of the housing is inserted into the guide slot, and
the guide slot is arc-shaped.
